(19) United States
(12) Patent Application Publication
(10) Pub. No.: US 2007/0243887 A1
(43) Pub. Date: Oct. 18, 2007

(54) PLATFORM FOR TELEPHONE-OPTIMIZED DATA AND VOICE SERVICES

(75) Inventors: Jagadish Bandhole, Saratoga, CA (US); TK Lakshman, San Carlos, CA (US); Sekaran Nanja, San Jose, CA (US)

Correspondence Address: PILLSBURY WINTHROP SHAW PITTMAN LLP, P.O. BOX 10500, MCLEAN, VA, 22102, US

(73) Assignee: fonemine, Inc., Sunnyvale, CA (US)

(21) Appl. No.: 11/555,673

(22) Filed: Nov. 1, 2006

Related U.S. Application Data
(60) Provisional application No. 60/732,792, filed on Nov. 1, 2005.
(60) Provisional application No. 60/742,705, filed on Dec. 5, 2005.
(60) Provisional application No. 60/771,724, filed on Feb. 8, 2006.

(51) Int. Cl. H04Q 7/20

(52) U.S. Cl. 455/461

(57) ABSTRACT

Systems, apparatus and methods are described that provide abstractions, tools and delivery systems useful in the publication, sharing, viewing, communication, transmission and reception of information on telephone networks. The invention also provides systems, apparatus and methods for conducting transactions on telephone networks. The systems, methods and apparatus can be optimized for use in mobile devices and may be addressed using existing telephone numbers. The abstraction typically maintains a built-in location capability. A plurality of tools are provided including a language for rendering information on telephone devices, and a protocol for enabling communications between telephone devices. In some embodiments, personal and business telephone numbers can be associated with addressable useful information about that telephone number. In many embodiments, the invention enables the calling of a telephone number to initiate voice communication in a manner identical to accessing published information associated with the target telephone number or user.

### CROSS-REFERENCE TO RELATED APPLICATIONS

The present application claims priority from U.S. Provisional Patent Application No. 60/732,792, entitled “PLATFORM FOR TELEPHONE-OPTIMIZED DATA AND VOICE SERVICES,” filed Nov. 1, 2005 and which is incorporated herein by reference and for all purposes. The present Application is also related to U.S. Provisional Patent Application No. 60/742,705, entitled “Digital Personal Assistant And Automated Response System,” filed Dec. 5, 2005 and U.S. Provisional Patent Application No. 60/771,724, entitled “Telephony Based Publishing, Search, Alerts And Notifications, Collaboration, And Commerce Methods,” filed Feb. 8, 2006, which applications are incorporated herein by reference and for all purposes.

### BACKGROUND OF THE INVENTION

1. Field of the Invention

The present invention relates to data communications and more particularly to voice integrated data communications in data access devices including telephones and computers.

2. Description of Related Art

The world of voice telephony communications started in 1876 with the invention of the telephone. Telephone communications have focused on a landline telephone as the common endpoint, and a telephone number as the globally unique addressing and routing mechanism, with location information built-in to the end-point addressing. The acceptance of mobile telephony communications in the mainstream during the 1990s resulted in end-points being extended to include mobile devices, using the same telephone number structure for end-point addressing. However, telephone communication is primarily voice driven with a caller either talking to the recipient or reaching a voice mailbox associated with the recipient. Additionally, data communications using telephone lines has been limited to passive Faxing and unidirectional messaging using, for example, short messages (“SMS”). Importantly, in the world of voice telephony, data communications is not well integrated with voice communications.

Mobile telephones most commonly use SMS for text messaging and other simple data-centric communications. However, SMS is limited by text size and by a lack of many basic and advanced communication protocol features such as structure, sessions, sequencing of received data, and non-text formats. Currently, SMS can send only text format messages, precluding the use of rich data such as images, sound-bites, hyper-links and rich text. The lack of features limits functionality and affects navigability, linking, and other structured navigational mechanisms. Furthermore, common mechanisms of collaboration and group organization are lacking in SMS based communications. An SMS message addressed to 10 people results in 10 messages being sent and each reply can only be sent back to the original sender, thus preventing group collaboration and sharing. Additionally, SMS and traditional web technologies have predefined notions of location which limits their ability to provide location based services.

Finally, the advent of internet in the 70s led to an explosion in data communications based on networking protocols (TCP/IP) that use IP-addresses (and host-names) to identify end-points. TCP/IP and the Internet provide a fundamentally different environment from voice protocols and telephone/voice networks. The creation of the World Wide Web (www) in the mid-90s through the HTTP protocol (layered on top of TCP/IP) and HTML as a data presentation/rendering language, led to an explosion of publishing of content on web-sites to be viewed using browsers. However, such content makes significant assumptions about the protocols, the presentation language and end-points, including for example
i) end-points support easy text I/O using keyboard and mouse,
ii) large viewing area on end-points supporting browsers,
iii) runtime environment on end-points to support rendering of rich content,
iv) ample CPU and memory on end-point devices,
v) end-points support navigation and object selection using point and click,
vi) network provides significant bandwidth between server and client,
vii) limited access to client location in content creation and publication,
viii) end point identity and specific location are unknown to the content service (for typical content sites which don't require login/authentication access, or can't make granular determination of the location of the end point, including most content sites),
ix) sessions supported by communications protocols.

Unfortunately, none of these assumptions are met by current telephone devices or conventional telephone communication protocols, resulting in web content, and content rendering that is ill-suited for current telephone devices. The current mobile web, while broadly accessible on most phones and networks, is one-dimensional, cumbersome to use and is not optimized for mobile user experience. Furthermore, the current mobile web does not enable full user participation through user-generated content on mobile, in part because most online content, applications and services today are built for the PC web and retrofitted for mobile phones as an afterthought.

### BRIEF SUMMARY OF THE INVENTION

Aspects of the inventions described herein resolve many of the problems associated with the prior art. Systems and methods are described that provide easy to use tools for facilitating personalizable, interactive mobile publishing and for enhancing telephone functionality such that full participation of users and groups is enabled through data services provided on telephones.

Systems, apparatus and methods are provided that overcome problems associated with the development, deployment, and delivery of information services for data access devices such as telephone devices on telephone networks. A platform (hereinafter “Fonemine Platform”) for rapid development, deployment and delivery of such services is described. In certain embodiments, various telephone devices can be supported by Fonemine Platform, including mobile telephones, cell-phones, smart telephones, land-line telephones, gaming devices, computers, music and picture viewing devices and PDAs. In certain embodiments, Fonemine Platform utilizes any suitable low level protocols such as SMS SMPP, GSM, GPRS, CDMA, 3G, etc., and application level protocols such as WAP and HTTP to communicate with mobile devices. Similarly, Fonemine Platform can use network level protocols such as TCP/IP and public switched telephone network (PSTN) and application level protocols such as HTTP to communicate with wired devices such as landline telephones and end-point computers connected to the Internet. Fonemine Platform enables users such as ISVs, content owners and providers, telecom operators, messaging software vendors, small businesses and franchises, advertisers and device manufacturers to rapidly create and deploy new voice integrated information services targeting consumers, business-consumers, advertisers and enterprises.

Embodiments of the present invention resolve issues in the prior art by enabling rapid service creation and delivery of content to and from data access devices such as telephone devices on a telephone network, through the use of Fonemine Platform. Certain embodiments provide data content and services that can be customized and optimized for telephone end-points, leveraging viewer location. Fonemine created data services are typically bidirectional, active, multi-modal (identical mechanisms can be used to initiate voice calls and access to data and to transition between voice and data access), easy to navigate in comparison to voice navigation and can be integrated with traditional voice services. In many embodiments, navigation of data can be either text-menu-driven or voice-menu driven. Additionally, since telephone technology continues to be far more ubiquitous than internet end points, many embodiments include a content description, rendering and publishing language to overcome significant processing, memory and input/output issues associated with telephone keyboard and display, as well as navigational challenges associated with telephones and traditional voice networks. Further, in many embodiments, rich content can be rendered on supported telephone devices. For example, content can be dynamically translated from visual presentations of text and graphics to audio presentations of information extracted from the text and graphics. Certain embodiments of the invention provide an application level communications protocol that can overcome bandwidth limitations on traditional telephone networks. Furthermore, cell-phones have become a human accessory akin to clothing, thus leading to a significant demand for information access in an “almost always connected” world.

Embodiments of the present invention provide a content abstraction called a Fonepage which provides a container for rich content (text, rich text, hyper-links, media objects such as images, sound, and video) and basic data-structures used to publish, share, view, send and receive information and to accomplish transactions on telephone networks. Fonepage abstraction can be optimized for communication and viewing on mobile devices and may be addressed using existing telephone numbers. Further the Fonepage abstraction typically maintains a built-in location capability. Fonepage optimizations can be achieved using a plurality of tools including a new language (hereinafter “FONL”—Fone Optimized Network Language) for describing, rendering and publishing Fonepages on telephone devices, and a new protocol (hereinafter “FONP”—Fone Optimized Network Protocol) for data communications that enables telephone devices to rapidly communicate and share content with each other and with a central Fonemine service. In certain embodiments, FONL, FONP and Fonepages form the core components of a platform for rapid creation and delivery of information services targeting telephone devices. With the Fonemine platform, any telephone number can have an associated Fonepage which publishes useful information about the telephone number. A business Fonepage associated with a business telephone line can contain business specific content such as business hours of operation, services provided, pricing, promotions, etc. A personal Fonepage associated with a personal telephone number can contain personal information such as identifying information, preferences, contacts, interests and other such information selected for sharing with callers. A Fonepage associated with a telephone number may provide an ability to personalize, publish and disseminate information in response to a call made to the telephone number.

In certain embodiments, an identical process can be used for calling a telephone number to initiate voice communication and sending a text message to a telephone number as can be used for accessing a Fonepage associated with the target telephone number or user. The caller can choose from options including talking to the target user, accessing the target user's voice mail and sending a text message to the target user and the caller may additionally access the target's Fonepage. Accessing the target's Fonepage can result in the display of displayable Fonepage information on the caller telephone, or the presentation of audio by the caller telephone using a text to voice converter. Any user having a telephone number, can publish their Fonepage, customize their Fonepage based on caller characteristics, including location, time-of call, caller-identity etc., and can view other users° Fonepages simply by addressing their telephone number by means of a telephone that supports viewing Fonepages.

In certain embodiments, globally unique telephone numbers can be used as personal URLs. In some of these embodiments, an interface, described herein as a Fonepage, can be accessed through a telephone number wherein the Fonepage provides a visually richer interface constructed as a mobile-Wiki and fully compatible with standards like HTTP, XHTML, WML, WAP, SMS. The Fonepage is typically, lightweight, phone-optimized, fast and easily created and used. Subscribers can publish, interact, network and communicate in various modes including push, push-pull, one-to-one, one-to-many, voice, text and rich data modes.

In some of these embodiments, a novel concept described herein as Fonenames can expand subscriber mobile communications and people networking capabilities through personal vanity tags without sacrificing their phone-number privacy.

In certain embodiments, consumers and businesses may maintain a data presence on telephone networks, and can easily create content and applications designed specifically for mobile users. Consumers and businesses may publish interactive and personalized information, communicate using data services through carriers and devices, leveraging the phone number namespace and expanding it using Fonenames. Presence on a mobile data network can be achieved without the need to deploy or maintain IP addresses, domain names, web and application software, server software, networking infrastructure and web publishing tools. Certain embodiments provide simple, turnkey, hosted alternatives to current systems and enable consumers and or businesses to maintain a Fonesite that can include personalized, interactive, voice-integrated Fonepages that can be created quickly and easily. Aspects of the invention enable easy sharing of content with one or more mobile communities using conventional communications systems and methods such as SMS, HTTP and WAP.

In certain embodiments, URL mapping is provided to permit access to Fonesites through conventional web URLs, standard search engines and mobile-friendly domains such as dot-mobi. Thus, it will be appreciated, aspects of the invention enable creation of far reaching applications for wireless carriers, Internet companies, content providers, businesses and advertisers and create opportunities in the mobile ecosystem because content and services can be provided on a telephone-native network platform.

The foregoing and other aspects of various embodiments of the present invention will be apparent through examination of the following detailed description thereof in conjunction with the accompanying drawings.

### BRIEF DESCRIPTION OF THE DRAWINGS

The present invention is illustrated by way of example, and not limitation, in the figures of the accompanying drawings in which like references denote similar elements, and in which:

FIG. 1 illustrates a conceptual system diagram of an embodiment of the invention;

FIG. 2 provides an operational overview of an embodiment of the system;

FIG. 3 depicts protocol stacks used in one embodiment of the invention;

FIG. 4 depicts an example of network architecture in one embodiment of the invention;

FIG. 5a is a flowchart describing a subscriber sign-on in one embodiment of the invention;

FIG. 5b is a flowchart describing a simplified access and browse process in one embodiment of the invention;

FIG. 5c is a flowchart describing an example of a coupon delivery process as implemented in one embodiment of the invention;

FIG. 6 shows an example of a simplified Fonetop display;

FIGS. 7 and 8 provide examples of content display in an embodiment of the invention;

FIG. 9 is a flowchart illustrating a search process in one embodiment of the invention; and

FIG. 10 is an architectural drawing showing one implementation of a network in one embodiment of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. In the drawings, like components, services, applications, and steps are designated by like reference numerals throughout the various figures. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

Certain embodiments of the present invention enable the provision of enhanced services on communications devices including, for example, cellular telephones, personal data assistants, conventional telephones (public switched telephone network “PSTN”), tablet and mobile computers, and so on. In certain embodiments, the communications devices have limited user interface capability. In certain embodiments, displayable data can be provided in response to a telephone call to a subscriber of the system such that a calling device may display text and graphics data formatted for the calling device and related to the subscriber. In certain embodiments, displayable data is optionally presented to the calling device as a voice response by translating text to voice. In certain embodiments, the displayed data is pre-converted to plain text and presented to the calling device as a text message (SMS). The telephone call is typically initiated by dialing a subscriber telephone number. The text message can also be created by entering a subscriber telephone number in a recipient telephone number field of the text message creation menu. The data may include information of general interest such as contact information, availability information and links to further information, typically organized by category, keyword, subject, and so on. Where the subscriber is a business, the information may include commercial messages, details of products and services, marketing, contact, location and other such information. In many embodiments, the caller may initiate one or more actions by selecting from various options presented in the data. These actions can include options to browse, search, navigate, save, click on a link to click on a link to access one or more Fonepages or initiate a voice call, input a message or other text information, retrieve coupons and redirect to other subscribers. In certain embodiments, these actions can be voice driven.

Further, in certain embodiments, a caller may establish a telephonic voice connection call by selecting an option provided in the information. Calls may be established with a communications device associated with the subscriber telephone number dialed by the caller. Optionally, a selectable call option may cause a telephonic connection to be established between the caller and a communications device designated by the subscriber. Thus, for example, a call can be directed from a cellular telephone to a designated land-line telephone. Further, certain embodiments enable the establishment of integrated text, voice and multi-media connections between the caller and the subscriber. As will be described in more detail below, content of the information can be highly customized and customized information can be further reconfigured automatically based on factors including location of subscriber, location of caller, a selected other location, identity of caller, access rights of caller and time of day and other calendar-based information.

Embodiments of the invention provide an interface that enables users of the mobile devices to access networked services including personalized applications, personal data, and shared information. For the purpose of this discussion, servers, tools and network protocols configured for the provision of the disclosed services will be referred to as “Fonemine Platform.” In certain embodiments, Fonemine Platform abstracts low-level protocol specific operations and device-specific functions from application software and users. This abstraction can enable the provision of a set of core services to subscribers by mapping the core services to generalized high level control commands and services. These high level commands and services can be invoked using applications that perform any desired function including publishing, search, inventory management, scheduling, reservations, personal information manager (PIM), event management, invitations (Evites), and other collaborative functions including, for example, m-commerce, where mobile devices are used for transactional operations such as “buying something e.g. a can of coke”, “reserving something e.g., a parking spot”, or “starting/stopping a reservation e.g., a parking spot.

In certain embodiments Fonemine Platform enables integration and invocation of existing applications and provides a framework for developing new applications and services using a set of APIs. Fonemine Platform typically implements all low level functionality needed to publish desired content, view or hear desired content, or to build any mobile application or service.

In many embodiments, Fonemine Platform defines at least two categories of users: publishers and viewers. Publishers include businesses seeking to optimize interaction with customers and targeting existing and potential customers, service organizations (such as government, marketing, essential services) seeking to better disseminate and gather information from consumers, entertainment/content services such as news, music, videos, feeds, etc., seeking to attract viewers, telecom operators seeking increased average revenue per user (“ARPU”), small businesses seeking to reach out to and respond to their subscribers, advertisers seeking to reach potential targets in specific locations and demographic groups during an advertising campaign, and device vendors seeking larger footprint and market share. Publishers provide a revenue source for Fonemine via subscription and transactional business models. Publishers who also advertise their services provide another source of revenue through both subscription and transactions. The transactional model includes per activity—e.g. per call—as well as advertising revenues, whereas the subscription model includes a per month recurring revenue.

Viewers typically include consumers, typically owners of mobile devices, who receive enhanced information access, higher value, mobility, “coolness factor,” and sharing within communities. In some embodiments, some viewers may access Fonemine services at no cost. Other viewers may subscribe to a value-added service or pay for services as used.

In certain embodiments, Fonemine platform enables presentation of content as an abstracted and structured component (hereinafter referred to as Fonepage). Fonepages can be presented on any supported mobile device in a form adapted to the capabilities of the mobile device. In one example, a Fonepage is formed as a structured page that may be uniquely associated with a telephone number. In certain embodiments, Fonepages are optimized for the limited capabilities of a mobile device and may be further optimized for access using voice networks. In certain embodiments, Fonepages are location aware and content may be altered based on geographical information related to the mobile device.

Fonepages can comprise media rich text, hyper-links, images, sound and video clips and other content that may be displayed and viewed on a cell phone or other mobile device. Fonepages can be associated with one or more telephone numbers (rather that, e.g. a URL) and, in some embodiments, the one or more telephone numbers may be mapped to URLs, thus preserving accessibility and inter-operability with current mobile devices, protocols, and standards.

In certain embodiments, Fonepages comprise combinations of information types including, for example, personal data and preferences and information repositories such as telephone contacts, content favorites, calendar, events, meetings, pictures, ring tones, news feeds of interest, applications, games, and coupons. In one example, Fonepage content may be provided based on predetermined access-control rules that determine access rights afforded to users and mobile devices. These access control rules may be configured by owners of content, service providers, and may be limited based on temporal, demographic, and geographic factors.

In certain embodiments, the Fonemine Platform can provides producers or creators with an ability to create, update and organize collections of Fonepages, while enabling viewers to view Fonepages on their mobile devices. Fonepages can be business Fonepages, capturing business content or personal Fonepages capturing personal content, as well as advertising Fonepages capturing advertisements. In certain embodiments, Fonepages may be created with substantially different format and functionality from web-pages created for viewing on a conventional browser and web-pages delivered to mobile devices via protocols such as HTTP, SMS and WAP. Fonepages can be optimized to overcome mobile device presentation limitations such as display and data input limitations, as well as navigation limitations, and can be further optimized to maximize communication capabilities using limited function protocols such as SMS which has a relatively small maximum message size and is supported by most of the mobile devices. Furthermore, Fonepages can be optimized for delivery to mobile devices configured to use protocols such as GPRS/EDGE/UMTS/3G and CDMA IX, for providing high bandwidth data access. Thus, it will be appreciated that Fonepages capture certain benefits of available underlying protocols while providing some unique advantages.

In certain embodiments, Fonemine Platform simplifies delivery of services using standard telephone infrastructure by abstracting unnecessary low-level functions, thereby relieving service operators and application developers of the burden of accommodating a large variety of devices and infrastructure configurations. In certain embodiments low-level functions that can be abstracted to address factors that impact mobile device operation including protocol specific, device specific, operator specific, demographic and location specific factors.

In some embodiments, Fonemine Platform provides a plurality of features including telephone number centricity, telephone-viewability, portable personality for enabling a user to transfer personalities between devices, location-awareness, and voice/data integration. Additionally, in certain embodiments, the Fonemine Platform can be optimized for delivery using telephone equipment and can be protocol and infrastructure agnostic and device independent.

In certain embodiments of the invention, mobile devices are location-aware. Location-aware mobile devices enable the delivery of information appropriate for a current location. For example, a user requesting local services need not specify the current geographic location in requesting the local services. Some mobile devices may be inherently location-awareness through, for example, global positioning system (GPS), network identification and location information associated with the user and device, and user configuration. Some mobile devices may receive location information from a communications network, from other devices connected to the mobile devices (e.g. nearby Bluetooth connected GPS systems) and through calendaring systems.

In certain embodiments of the invention, services are provided to mobile users based on a telephone number or other subscriber or device identifier. Thus, a user may maintain data in mobile form and transfer data seamlessly to a substitute or replacement device by transferring numbers or modifying set up on a server. The user specific personal content may also be accessed/viewed/modified through a standard web-browser interface or through a web-client. In fact, often, the user makes changes to their Fonepages through a browser-based interface, previews the changes via this browser and/or mobile devices, and then commits the “publish” operation which enables the changes to be persistent and viewable from any mobile device that supports Fonepage viewing.

In certain embodiments, the interface provides voice and data integration services to the mobile device. Such integration includes the ability to specify commands to the Fonemine server via voice, the ability to receive data in the form of voice, and the ability to seamlessly go back and forth from data-access to voice-calls.

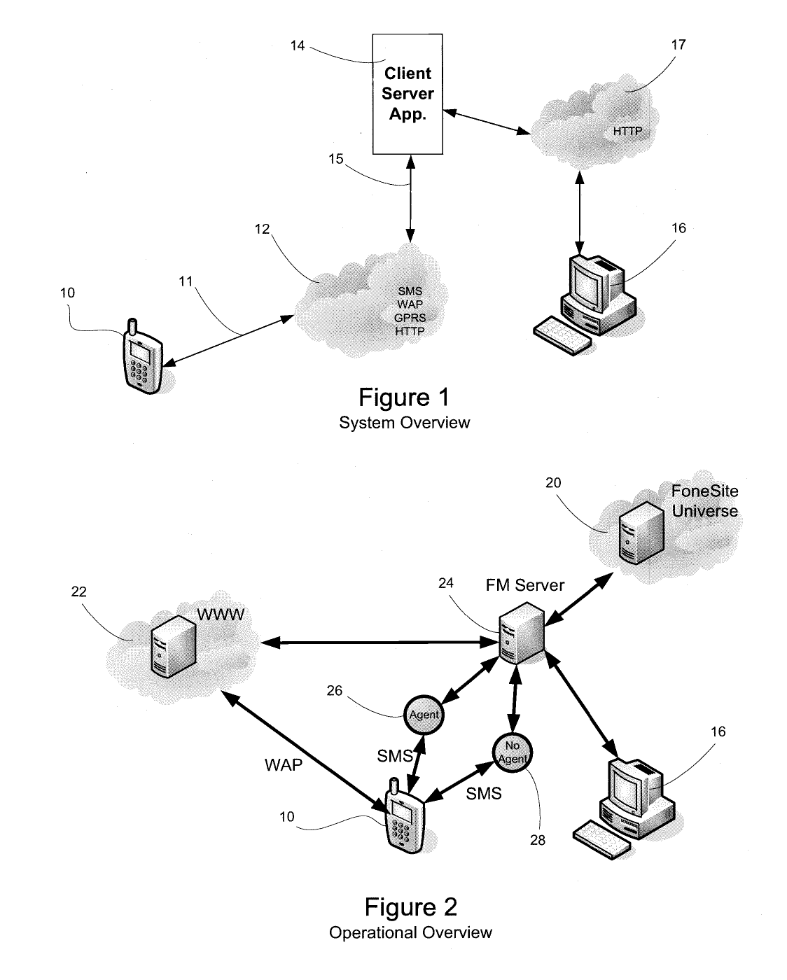

Referring now to FIG. 1, an example of a simplified Fonemine platform is illustrated. In some embodiments, users can access desired information through user device 10 that may be any suitable networked device including, for example, cellular telephones, smart telephones, fixed-line telephones that support SMS and data capabilities, personal digital assistants, handheld computers, notebook and other portable computers and so on. The user device 10 can connect with one or more network 12 using any available communications system 11 including CDMA, TDMA, GSM, PSTN, IEEE 802.1 1, satellite and so on. User device 10 can typically send messages using any suitable communications format including: GPRS, SMS, IP 3G and WAP. Typically, a desktop computer 16, workstation or other suitable computing platform may be used to create and maintain content on server 14 for delivery to user device 10. Desktop computer 16 can communicate with Fonemine platform servers 14 using any available networking system including the Internet 17 and, typically, content creation, editing and review by desktop computer 16 utilizes conventional protocols and languages such as HTTP, XML, IP and so on.

The operation of an example of Fonemine Platform may be better understood by reference to FIG. 2. In certain embodiments, one or more servers 24 provide an interconnection between conventional networks (such as the World Wide Web) 22 and a Fonemine platform enabled network (hereinafter “Fonesite universe”) 20. Server 24 typically translates between Fonepages and conventional web pages and procures web services on behalf of Fonemine platform enabled device 10. Additionally, server 24 can facilitate creation and management of Fonepages and other Fonemine platform content using desktop computer 16.

User device 10 typically communicates with server 24 using any available intermediate protocol supported by, for example, wireless service providers. For the purposes of this discussion, the example of SMS will be used as a method of transporting text and graphics data between user device 10 and Fonesite Universe 20. Typically, agent software 26 on user device operates to establish communication sessions with servers 24 using SMS to transport text and graphics data. However, in certain embodiments, service can be provided using only SMS transport 28. In this latter mode, information may be scaled for consistency with the capabilities of the SMS (or other) system 28 used for transport.

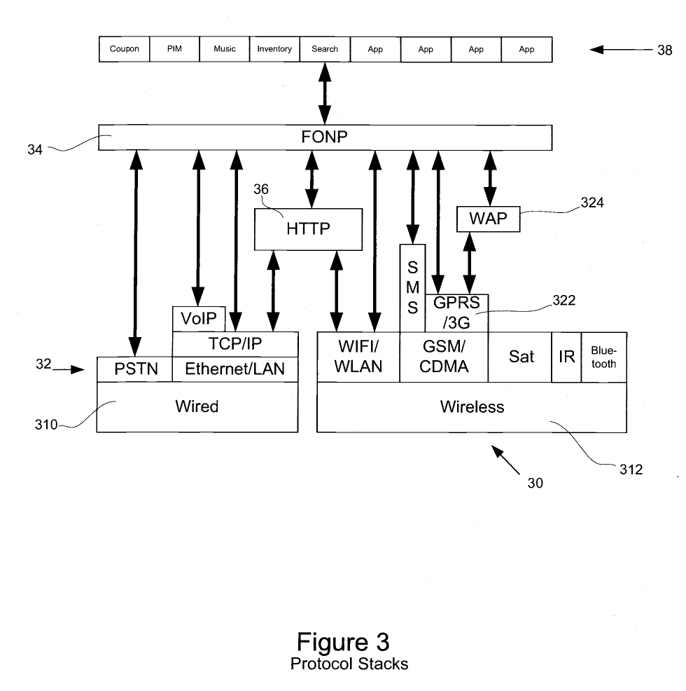

Referring now to FIGS. 2 and 3, an example of a protocol stack, indicated generally at 30, illustrates the relationship between protocols used in typical Fonemine Platform enabled systems. It will be appreciated that variants and subsets of protocol stack 30 can be implemented in both user device 10 and servers 24. Variant protocol stacks are typically customized based on capabilities and function of user device 10 and server 24. Variant stacks can be configured as components of agent software 26 in a user device 10. Typically, such agents 26 are configured to enable a plurality of desired services functions available in a Fonemine enabled system. Typically, agents 26 implement the plurality of functions using a combination of functions and resources native to the device 10 in which the agent 26 resides. In many embodiments, the plurality of functions can include call initiation, call management, data translation, search, data synchronization, device update services and protocol extension services. Protocol stack 30 can include components for interfacing devices with one or more physical network such as a wired network 310 (PSTN), Ethernet and wireless networks 312 such as CDMA, GSM (including SMS), TDMA and so on. In certain embodiments, various combinations of network 310, 312 may be used as necessary to maintain a desired quality of service where quality of service may be defined as including transmission speeds, response time, security of data transfer and temporal considerations.

In certain embodiments, data formats and communications may be configured for compatibility with available control protocols that may include, for example, GPRS 320 , 3G 322 and WAP 324. Data can be formatted by one or more agents 26 prior for processing by a selected control protocol. For example, an agent 26 may manipulate graphical data to provide an image optimized for a target user device 10, taking into consideration display capabilities and memory capacity of the target mobile device 10. In another example, an agent 26 may encrypt data for transmission using predetermined encryption keys associated with a target user device 10.

In certain embodiments, a customized translation layer (hereinafter “FONP”) 34 can be used to manipulate data for optimizing interaction between devices, servers and other devices and components. FONP 34 typically provides a plurality of services adapted to support one or more user devices 10 associated with a subscriber. FONP can permit clients, including mobile clients, to communicate with the Fonemine platform. FONP is typically implemented as an application level API built upon a remote-procedure-call (“RPC”) library that enables clients to communicate with the Fonemine platform and associated servers. The RPC library can be configured to automatically create the server side and the client side code on a Fonemine platform and mobile device or computer, respectively, based on specification of the desired communication and certain capabilities of the client and the server. The FONP protocol and the associated library differs from traditional RPC mechanisms, such as SOAP in its ability to transfer control and code from the client to one or more servers embodying the Fonemine platform. This control and code transfer can enable server-side execution and can facilitate data transfer from client to server thereby better leveraging the limited capabilities of typical mobile clients and much richer capabilities of the Fonemine platform. Not only is FONP capable of recognizing and leveraging the capabilities of the clients and the Fonemine platform, it can also leverage a plurality of underlying protocols, thereby providing support for communications from mobile devices that have very different data service capabilities (e.g. SMS to 3G).

In certain embodiments, FONP can be provided as an application level phone communications protocol and API built atop a modular library. FONP can typically support fast communication between disparate clients (cell phones, cell phones with rich programming stack such as smart phones, web-browser on a cell phone, web-browser on a computer) and a centralized server. In certain embodiments, FONP may use services provided through protocols such as WAP and HTTP implemented on telephone networks. FONP may be cognizant of communication and local display, rendering and computing capabilities of client devices. FONP may be configured to leverage services provided by servers and centralized content and service resources. In certain embodiments, FONP implements an RPC capable protocol. Services leveraged by FONP can include serialization, communication encryption and optimization services.

In certain embodiments, commonly available programming models and programming languages may be supported in FONP. Such programming models and languages typically provide, or can be modified to provide exception handling, RPC support, polling capabilities for flow control and for leveraging optimization and communication capabilities of client and server. Typically FONP can recognize and leverage native content formats including text, images, sound, and video and can optimize rendering and communication of content on telephones and other mobile devices. In certain embodiments, FONP can be configured to pre-optimize, transport and post-optimize web content for efficient rendering, viewing and communication. In certain embodiments, FONP is configured to support content that employs combinations of forms, user input, dynamic services and dynamic content.

In certain embodiments, FONP includes a FONP API that permits mobile J2ME and device native applications to communicate with one or more Fonepage servers. Typically, the FONP API contains entry points for a client to request and retrieve Fonepages, create Fonepages, get/set contacts, login, logout, and to perform other operations necessary to access services on the server.

The FONP API can be built using a byte code library such as the Fonemine Byte Code (FMBC) library. The FMBC library can be provided as an object-oriented implementation of a RPC stack. FMBC can create client and server side code from an XML specification of an API. Unlike traditional RPC mechanisms (such as SOAP), FMBC can typically transfer data and portions of code from the client to be executed on a server as well. An FMBC programming language typically supports objects and classes, strong-typing, multi-dimensional arrays, semantic type checking, exceptions, and many other modern language features. Additionally, FMBC may automatically handle generation of an RPC skeleton, stubs, and may provide mechanisms to assist programmers change the API while preserving backward compatibility. In certain embodiments, FMBC can generate code that executes over plural underlying protocols. These protocols can include streaming protocols such as HTTP and TCP/IP, datagram protocols such as UDP and SMPP and SMS PDUs. In certain embodiments, FMBC generates server and client side code for C++ and Java implementations such as J2ME and J2SE.

In certain embodiments, FONP includes methods analogous to HTTP GET and POST operations, thus supporting dynamic content and forms. FONP can also include additional calls to execute server-side services, get/set objects on the server, get/post FONLC pages (FONL pages that have been compiled to a bytecode), poll for alerts from the server, do agent updates, and upload GIF/PNG/etc. images. Errors from the server can be translated into Java exceptions which can be caught and handled as necessary.

In certain embodiments, FONP may use URL mapping to uniquely translate telephone number specificity into specific Fonepages, thus preserving a 1-1 mapping.

The plurality of services provided by FONP 34 typically includes:
i) Account authentication for authenticating users requesting login access.
ii) Access control, including authorization of responses to user requests for Fonepages by, for example, verification of user credentials and access rights.
iii) Encryption services for ensuring that Fonepage data is adequately encrypted for the communication methods supported by a user device and for encrypting using methods supported by user client mobile device.
iv) Methods for resolving services from the platform (cf. HTTP GET)
v) Methods for calling/invoking services (cf. HTTP POST)
vi) Get and set resources on the platform/server
vii) Access services from the server, such as search services
viii) Methods for serializing and compressing to improve efficiency
ix) Methods for pre-processing content prior to transmission to improve efficiency
x) Logging for tracking communications and events.
xi) Event and Alert management for notifying users when certain configured criteria are met, including polling-based control.

In certain embodiments, the combination of FONP and FONL gives rise to significant efficiencies in transmitting and rendering Fonepages. Efficiencies are realized with regard to size and in communication speed and latency between client and server. Size reductions may be measured using factors of between 10-20, and greater reductions can be observed. Efficiency improvements may be derived from the “mobile centricity” of the FONL and FONP components. Traditional applications attempt to retrofit languages and protocols of the world-wide-web for creating and viewing content using telephones.

In certain embodiments, FONP can be used to transport content that uses other data formats such as XHTML, c-HTML, and HTML. In such application, server side operations such as scripting, processing, and client end point knowledge may be leveraged to obtain greater efficiency of application-level transport than would otherwise be available in traditional systems.

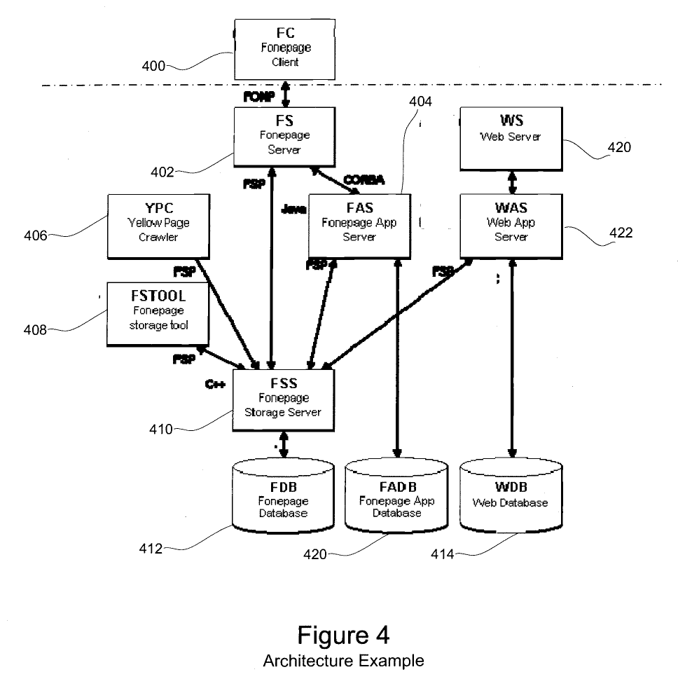

FIG. 4 provides an expanded view of functionality of the system in the example of FIGS. 1 and 2. In FIG. 4, services and functions are shown in logical form and it will be appreciated that such services and functions may be provided on a single server 24 or distributed across a plurality of servers 24, as desired. Fonepage storage server 410 maintains and manages Fonepage data in one or more Fonepage databases 412. Fonepage storage server 410 typically receives requests from application servers 404, search tools 406, data management tools 408, web interfaces 422 and from users through other Fonepage servers 402. In response to these requests Fonepage storage server 410 validates requesters access rights and optionally manipulates data as requested. Fonepage application servers 404 may also store data and software in an application database 420. Typically, information stored in the application database 420 is used for configuration and control of applications. Databases 414 may be maintained to cache Fonepages retrieved from Fonemine servers or Fonepages generated from content on the World Wide Web, to maintain translated Fonepages and for other purposes. Web servers 420 may be provided to serve Fonepage information to devices that are not Fonemine platform enabled. The Fonepage Server 404 can be accessed using a Fonepage Client 400, whereas the Web Server 420, may be accessed using web-client for publishing and web-management client for management of the Fonemine platform.

Referring still to FIGS. 1, 2 and 4, in certain embodiments of the invention, information can be dispersed or centralized and can be maintained on one or more network devices. For example, information may be duplicated, archived, shared and replicated between a server 14 and a user device 10. Additionally, in one example, information may be generated, viewed and manipulated on a user device 10 and a networked computing device 16, where both devices are associated with a subscriber or group of subscribers and the information can be stored on any combination of network server 14, user device 10 and computing device 16. In such an example, private information can be stored on the user device and computing device 16 while other information may be stored on the server 14.

In another example, duplicate copies of selected portions of the information can be distributed to a plurality of devices, whereby a synchronization scheme is typically established to propagate modifications or deletions of an instance of a duplicate portion on one or more of the plurality of devices. It will be appreciated that information distribution can span multiple sites within one or more countries and multiple sites across the world. The synchronization scheme can be configured to resolve inconsistencies in duplicate portions and dissimilar alterations of duplicate portions on two or more of the plurality of devices. The synchronization scheme may provide for the use of commonly available protocols such as Really Simple Syndication (“RSS”) or any suitable proprietary synchronization system.

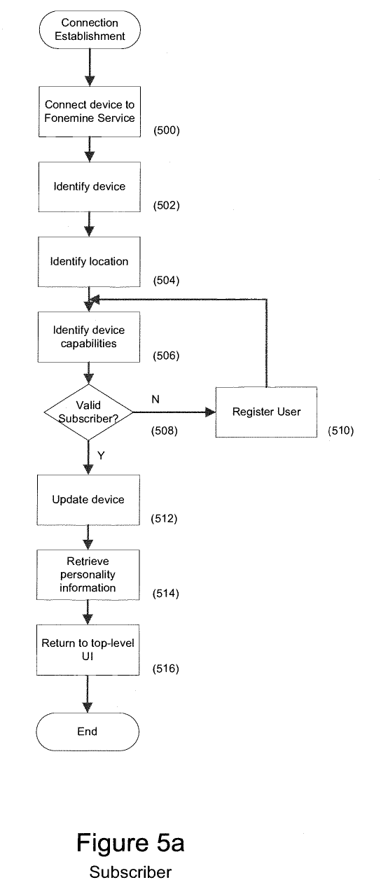

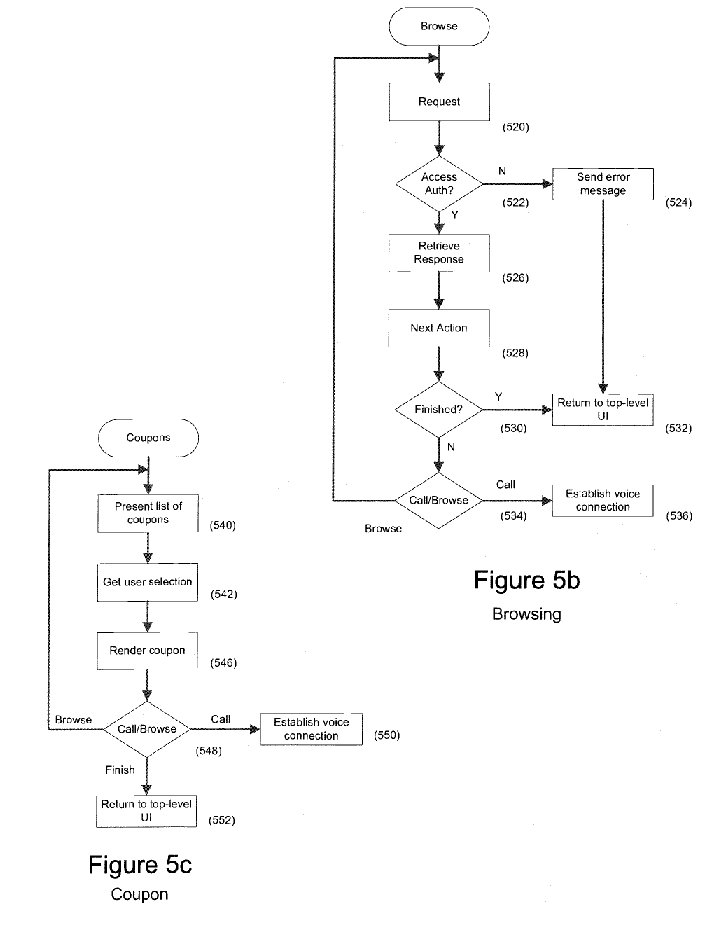

FIG. 5a is a flow chart showing an example of a registration and sign-on process used to validate a user seeking service in the example of FIG. 2. At step 500, the user device 10 is connected to Fonesite Universe 20. Fonesite Universe 20 identifies the user device 10 at step 502 and may ascertain the physical location of the user device 10 at step 504. At step 506, information obtained from the identification and location steps 502, 504 can be used to determine identity of a subscriber associated with the user device 10, characteristics of the user device 10 including display and user input capabilities, network protocol (e.g. SMS) availability and to characterize available services in the calling area and within the subscriber's calling plan. At step 508, the subscriber account status is verified to determine, for example, whether the user is a registered subscriber, whether the subscriber account is current and whether the user is authorized to obtain service in the calling area. If the user has no serviceable subscriber account, then at step 510 the user may be prompted to subscribe to a new account or to bring an existing account current.

At step 512, the user device 10 may be updated with new software and configuration information. Where the user device is connected for the first time or has been compromised or reset, a complete copy of agent software 26 and configuration parameters may be installed. At step 514, personality information is typically received from server 24 and used to customize information for display on the user device 10. At step 516, an initial display is provided at the user device 10, where the initial display typically provides options and actions that may be activated by the subscriber.

FIG. 5b depicts a flowchart that describes a browsing operation that may be performed by user device 10 in the example of FIG. 2. At step 520, a request is received from initial display or from within a selected Fonepage at the user device 10. At step 522, access control procedures can be invoked to determine whether a subscriber has sufficient access rights to view requested information or Fonepages. If the subscriber has insufficient access rights, a message can be sent to the user device 10 at step 524 and control may then be returned to the initial display at step 532. Where sufficient access rights are found, then at step 526 a response to the request can be formatted and provided at the user device 10 and, at step 528, further requests may be solicited. If, at step 530, the subscriber is finished browsing, control is typically returned to the initial display at step 532. However, if the user selects other options, then browsing may continue by repeating the process beginning at step 520.

Additionally, a call option may be selected on a plurality of Fonepages. Call options typically associate telephone contact information with text and graphics information provided in a Fonepage. One or more contacts may be provided in a Fonepage that, if selected can result in establishment of a connection between user device 10 and a telephone associated with the selected contact. Thus a voice connection may be established without further entry of telephone numbers. In some embodiments, voice and data connections may be established. In certain embodiments, numbers associated with selected contacts may be saved in a contact database for future rapid calling. In some embodiments, further voice integration can enable users to navigate using voice commands and to hear response Fonepages.

FIG. 5c shows a process by which coupons can be managed in a user device 10 in the example of FIG. 2. A subscriber may select a coupon option from a Fonepage or initial display and the system will typically provide a list of coupons associated with the subscriber at step 540. At step 542, the subscriber selects a coupon for viewing and the coupon is rendered at step 546. At step 548, the subscriber can elect to discontinue the operation and return to a Fonepage or initial display at step 552 or may choose to browse other coupons beginning at step 540. Additionally, the subscriber may choose to exercise the coupon and, by selecting this option, can be directly connected to a supplier of goods or services associated with the coupon at step 550. Typically this connection is established as a voice connection to a sales department.

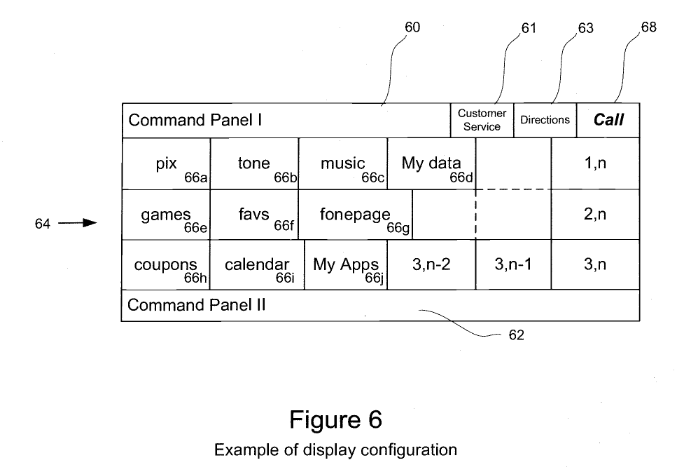

Referring now to FIG. 6, certain embodiments of the invention provide a normalized desktop for users (hereinafter “Fonetop”), indicated generally at 64. Fonetop 64 provides access to content, services and tools consistently configured and arranged in a manner customized by a user. Fonetop 64 can typically be viewed on any suitable device, including wireless consumer devices, telephones and notebook or desktop computers. Typically, Fonepage enabled systems can identify capabilities of a target device and adjust certain characteristics of a desired Fonetop 64 including display resolution, displayable colors, available storage and user input methods. In this manner, a subscriber may view, edit and create objects represented as 36a-36g that can be in the form of labels and titles. Fonetop enabled systems typically identify the capabilities of target devices using information received from network controllers, customized management devices, handshaking protocols, stored configurations and user profiles. Typically, Fonepage configurations can be controlled and configured by users, system managers and service providers. Fonetop 64 typically includes a first command portion 60, which may be located at or near the top of the display and a second command portion, which may be generally located toward the bottom of the display. The first command portion 60 typically allows subscribers to select an action or option provided in the display area. For example, the subscriber may enter a command in the first command portion 60 that initiates searching, browsing, for selection of specific media objects (such as ring tones, videos, songs, etc.), opening or closing of Fonepages and so on. The second command portion 62 typically receives commands that modify preferences that include layout, appearance and positioning of objects within the display.

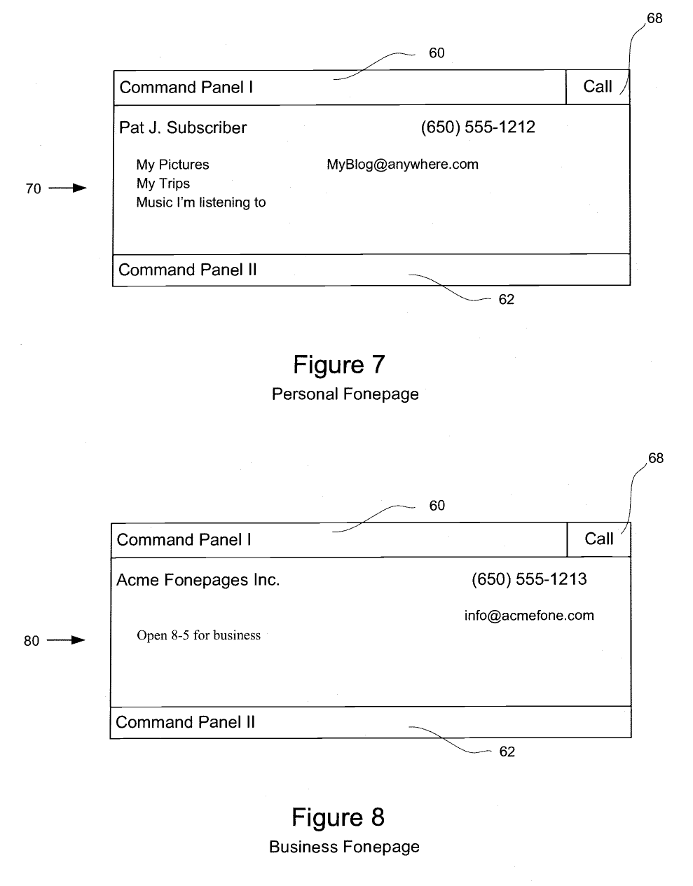

In many embodiments, Fonetop 64 enables access to a plurality of Fonepages. FIGS. 7 and 8 depict examples of Fonepages for an individual subscriber and a business subscriber, respectively. In certain embodiments, Fonetop 64 and Fonepages 70, 80 include a call option 68 that is typically displayed in the first command portion 60. Selection of call option 68 typically initiates a telephonic connection between user device 10 (FIG. 2) and a telephone identified by the call option 68. The identified telephone can be globally related to a currently displayed Fonepage 70, 80 and, in some embodiments, may be dynamically associated with a subscriber-selected field of the current display. Thus, a subscriber can identify, with one or two keystrokes, an item of interest and initiate a call to a telephone number associated with the item without conscious knowledge of the value of the telephone number.

Additional call options 61, 63 may be provided in first command portion 60 and second command portion 62, and some of these additional call options can be maintained as persistent options throughout a browsing session. For example, a customer service call option 61 may be maintained by a Fonepage provider and by a service provider in all Fonepages. In at least some embodiments, the customer service call option 61 may be configured dynamically based on context of browsing, location and other such information. In another example, a directions option 63 may provide a voice connection or written directions based on current telephone location.

Fonepage content may be arranged or displayed according to predetermined requirements received from content providers, service providers and subscriber preferences. In certain embodiments, Fonepage information can be created and configured using a publishing application. Publishing application is typically executed on a personal computer, network server, Internet website or other system that can be adapted to provide graphics design and data management services. In certain embodiments, a Fonemine platform includes one such publishing application which is available to all subscribers via a browser on a computer or a mobile application. A Fonepage is described using FONL syntax: which also includes directives on how to display the Fonepage on specific devices.

In certain embodiments of the invention, information extracted from Fonepages can be presented on limited functionality telephones. For example, where a telephone has limited or no display capability, information in Fonepages can be translated to audible form and transmitted to the limited functionality telephone. Response may be received as a combination of touch-tones and spoken word. Typically, text to voice translation is provided at one or more designated Fonemine servers. It will be appreciated that a subscriber's account information combined with location information can be used to select characteristics of the translated audio information. For example, a business subscriber may indicate options of language and dialect for certain Fonepages and the language and dialect may be selected based on location of a caller.

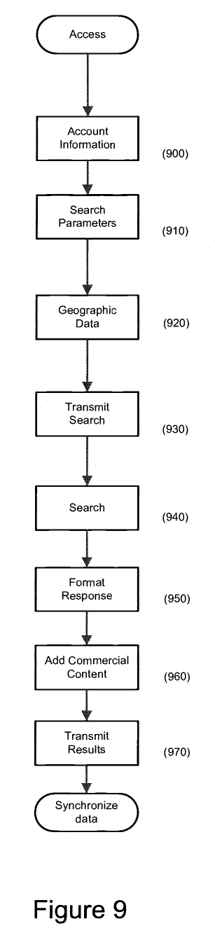

FIG. 9 is a flowchart describing one example of a method for accessing Fonepages and synchronizing data in a system. Typically, searches take into consideration, prior search terms, parameters and results and this prior information can be retrieved at step 900. At step 910, the subscriber provides current search terms and parameters. Geographic information is typically obtained at step 920 to prioritize results based on calling area or subscriber preferences. At step 930, the search can be dispatched and, at step 950, responses are retrieved and formatted for display based on the account information including device capabilities, language selections and display preferences. At step 960, commercial messages including advertisements and coupons may be included in the response and the response can be subsequently dispatched at step 970.

Typical Fonemine Platform Components

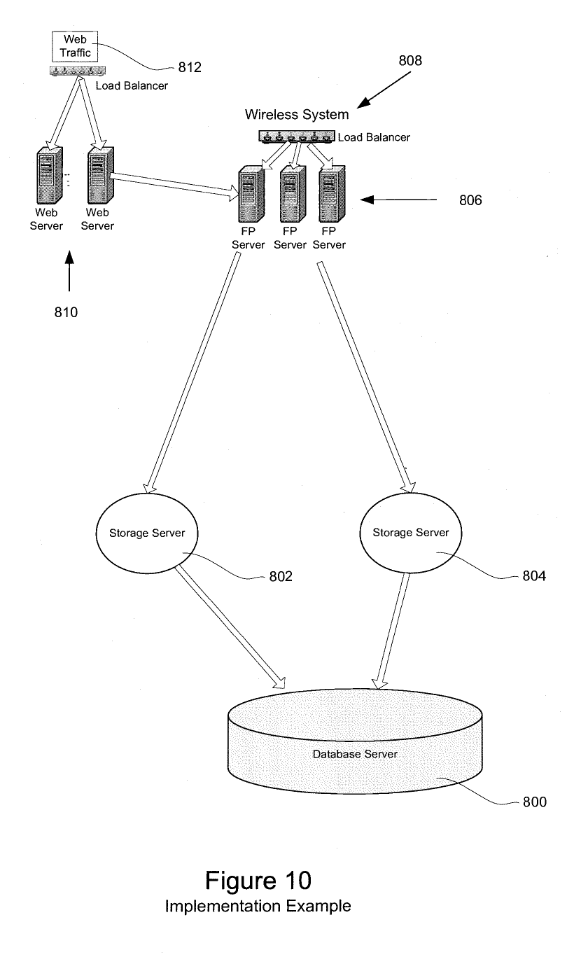

FIG. 10 illustrates a typical implementation of a Fonemine Universe and shows one component implementing functionality, typically in one geographical area. For example, the geographical area may be the eastern seaboard of the USA or a European country. In the example, one or more database servers 800 maintain data for the geographic area and storage servers 802 and 804 manage and maintain data in the databases. A plurality of Fonepage servers 806 typically handle requests from subscribers, translate data between conventional web pages and Fonepages and access data requested from Fonemine-enables wireless networks 808 and from the web servers 810 and the world wide web 812.

Referring back to FIGS. 1-4, in certain embodiments, Fonemine Platform can include a client application (“Fonepage Client”) 400 that may be executed on mobile device 10. Fonepage Client 40 can operate to receive Fonepages from Fonepage Servers 402 and display Fonepages via FONP 401. While Fonepages are typically received from servers 402, they may also be received directly from other Fonemine enabled devices. In some embodiments, Fonepage Client may perform certain functions typically associated with a web browser, including rendering of pages authored in HTML and XML, display of images and graphics and multimedia playback.

In certain embodiments, client software 400 is installed on mobile device 10 by download from servers 402, a networked device or at time of manufacture. Client software 400 may include agent software 26 although, in many embodiments, agent software 26 can be separately preinstalled by download during device manufacture or during configuration by service providers or equipment distributors. Client software 400 download can be effected using any suitable networking technology and protocol including Bluetooth, infrared, USB and by direct wireless connection to wireless service provider. Client software may be obtained by direct connection to a server but is typically staged in an intermediate server or on a desktop computer. The client software is typically registered or otherwise installed on an operating system in the mobile device and may use operating system services. In certain embodiments, the client software may be installed as one or more native components. In many embodiments, the client software is installed using standardized platforms such as Java MIDP2.0.

In certain embodiments, clients can include a native or installed mobile browser on a mobile phone, typically configured to access the mobile Internet. Mobile browsers can include WAP (wireless access protocol) browsers that use WAP to access mobile sites. Mobile sites can publish content in XHTML (extensible HTML). In certain embodiments, Fonemine platforms and services use FONP as an alternative to WAP and FONL as an alternative to XHTML whereby FONP and FONL are used except where device capabilities dictate the use of WAP, HTTP text messaging. In certain embodiments, efficiencies of FONP provide benefit even where a device requires the use of WAP to access a Fonesite or Fonepage. Efficiency improvements of FONP can be observed in latency, packet transfer rates and quantities, size of the original mobile content, and in user experience. Furthermore, Fonemine platform can facilitate creation and publication of mobile content in FONL usable by end consumers.

In certain embodiments, one or more servers 402, 404, 406, 408, 410 can be implemented to support specialized, customized and optimized content and services in a Fonepage enabled system. The one or more servers 402, 404, 406, 408, 410 may include Fonepage Servers 402 for generating and serving Fonepages, Fonepage Application Servers 404 for generating dynamic Fonepages and processing user input solicited or prompted from Fonepage forms, and Fonepage Storage Servers 410 for storing, caching and managing Fonepages and resources associated with Fonepages. Fonepage Storage Servers 410 can include Fonepage storage tools for managing Fonepages and interfaces associated with Fonepages.

In many embodiments, Fonemine abstractions provide seamless access to data in a consistent format based on personality information associated with a user and presented in a form optimized for the device used for access. In one example, user devices may execute configurable software (hereinafter “Fontop”) that enable users to view and operate on Fonepages. Fontop may include translation components that adapt received Fonepages and other information for presentation on the user device in a manner consistent with user device capabilities and consistent with user preferences. Similarly, certain translation services may be provided in the user device for abstracting information transmitted from the user device to other networked devices.

Fonemine Platform Protocols

In certain embodiments, Fonemine Platform includes programming languages and communication protocols that have been customized and optimized based on device capabilities. Fonemine Platform languages can include data description, rendering and publishing language (hereinafter “FONL”) for adapting Fonepages for display within the capabilities of a user device. Fonemine Platform protocols typically include one or more optimized network protocols for communication between client and server applications, or between various server components for management of Fonepages and their resources.

In certain embodiments, FONL can be implemented as a rendering adornment language that includes directives for Fonepages. FONL can simplify the creation of Fonepages and enable the implementation of a “Mobile Wiki.” For example, FONL can be layered atop a traditional rendering language such as WML, XHTML, HTML, c-HTML and, in certain embodiments, FONL embraces elements of the philosophy behind the well-known Wiki system in order to provide a very lightweight, simple, easy to use tool that may find application in collaborative and publishing environments which would benefit from simple tools implemented on cellphones and other mobile devices.

In certain embodiments, FONL can be implemented as a markup adornment language with directives used to render content pages (e.g. Fonepages) on mobile phones. FONL can be optimized for simplicity, compactness, mobile phone specificity, and minimalism of round-trips during communications between clients and servers. FONL typically operates at lower levels than typical mobile content markup languages to overcome restrictions arising from the nature of mobile telephone user interfaces that can blur the distinctions between content and presentation. In certain embodiments, mobile device characteristics such as soft keys can be leveraged to deliver an optimized user experience.

In certain embodiments, a multimedia content generator for mobile devices is provided that comprises a page creation tool configured to generate from the multimedia content information presentable on a telephone. The page creation tool can include software configured to be executed on one or more servers, on a dedicated computer or on a user computer. The page creation tool typically obtains multimedia content from the one or more servers and extracts a portion of the content for conversion to a form suitable for a telephone or mobile device. In some embodiments, the portion can be identified in the context of a telephone call directed to a subscriber such that preferences, rules and status of the subscriber or subscriber's phones is determinative of which content should be provided. For example, if a subscriber is unavailable, a text, voice or audio-visual message could be presented to a caller. The message can be retrieved from the one or more servers and converted to some combination of a Fonepage, video clip and audio clip. In certain embodiments, the page creation tool may generate source code for a displayable page that includes links to audio and video clips. In some embodiments, source and clips are bundled for transmission to a telephone. Source code may be generated using any suitable tool, including rendering adornment language based tools. Transmission of the source code may include the use of a connection-based protocol that interacts with SMPP for exchanging data and instructions between the one or more servers and at least one telephone,

In certain embodiments, FONL comprises a display component (hereinafter “Fonltext”) and a metadata component (hereinafter “Fonlmeta”) and can be transmitted in a highly compressed and compact form. Fonltext can describe how a page should be rendered and may be implemented as text annotated with simple markups to identify formatting. Formatting may resemble the source of Wiki pages to facilitate use and editing, and to simplify client side components and capabilities typically required to render data. Fonlmeta may be implemented as a collection of name/value pairs providing values for various attributes of a Fonepage. The attributes abstracted by Fonlmeta are typically directed to use by a Fonepage Server rather than by clients.

Certain embodiments include a file management component for managing file systems and data storage in the system and on associated networks. File management components are typically used to manage information regardless of physical location of the information in a system. File management components can provide seamless access to subscriber information by retrieving information on demand, caching information at servers that are logically proximate to a specified user device and by caching portions of the information on selected user devices. In certain embodiments, the file management component can replace, augment or coexist with local and network file systems and can provide a variety of capabilities including provisioning, allocation, configuration and synchronization of storage within the system and on the associated networks. In certain embodiments, the file system includes a component that facilitates interoperability of commercially available and proprietary file systems.

Certain embodiments provide security components for maintaining integrity of stored data. The security components may include user identification, user authentication, device identification, device authentication, access control to devices, access control to data and encryption components. Some examples of access control are provided as follows:
i) Configured access—access to a first user's Fonepage by a second user can be enabled by configuration of access control information such that first user or system administration may grant read, read/write, create, delete and other access rights to second user.
ii) Access by rule—access to a first user's Fonepage is granted when conditions specified by first user are met; conditions include, membership of one or more groups, time of day, location, busy status, make busy status and busy status dependent on group membership (i.e. receive voice call from first group but direct calls from second group to Fonepage).
iii) Public access—Fonepage generally available to any third party including, for example, customers and potential customers in a commercial application.

Certain embodiments include a plurality of applications customized for Fonemine enabled systems. Customized applications include search tools, publishing tools, advertising and coupon management tools, inventory control tools, ecommerce, instant collaboration tools, personal information managers (hereinafter “PIM”), scheduling tools, reservation tools, event coordination tools, alerting and notification tools, and electronic invites. The operation of these tools will be provided in greater detail below.

Fonemine Customized Applications

Certain embodiments provide an instant collaboration tool for supporting multimedia communication sessions between a plurality of user devices and network servers. A master organizer can be any user of the system and participant users of the system or guests of the system may be invited to join a collaboration session. Master organizer typically creates a profile of a desired collaboration session. Profile can include a session name, a list of desired participants, a category or type of session, proposed time for connection and so on.

Certain embodiments of the invention support live feed of multimedia data to a user device. The multimedia data may be received from a network service provider, from a network server or, in at least some embodiments, directly from another user device.

Embodiments of the invention provide various combinations of application that are customized for Fonemine Platform. Included in these customized applications are:
Publish for creating, configuring, publishing and maintaining Fonepage content.
Search tools for searching Fonemine enabled devices and Fonepages.
Marketing tools for distributing advertising, coupons and micromoney.
Inventory and storefront management tools.
M-commerce tools for facilitating.
Instant collaboration tools as described previously.
Online PIM services.
Scheduling and reservation tools for managing, sharing and leasing shared physical and virtual resources.
Event management tools including invitation generation and attendance management.
Directory assistance tools including location aware and user centric assistance.
Toll-free navigation and action tools.
Forms based field service and support tools.
Alert services for providing automated alerts responsive to configured events such as specific content availability.
Fonepage indirection for rules-based redirection of multimedia calls between telephone numbers.
Temporary Fonepages configured to be accessed for short duration and based on events, alerts and scheduling.
Keyword-based Fonepages.
Location based services including directions, local services identification, local interest, etc.; services may be based on location of call origination, reception, or other selected location.
Rules-based tools for automatically generating and customizing Fonepages including responses to incoming requests.
   Fonemine Network Services

Many embodiments provide services that enable users to search local storage, Fonemine managed information and external information, including the World Wide Web. In one example, a “Yellow Pages Crawler” (or “YPC”) can be implemented for crawling the web to populate Fonepages with collected yellow page information regarding businesses.

In some embodiments, customized web servers provide translation, customization and gateway capabilities for web browsing using a mobile device. Customized web servers can translate web pages to formats suitable for transmission to mobile devices. In at least some embodiments, web page translations provide web pages using other Fonemine-customized applications and services including a Fonepage editor for providing Fonepages.

In certain embodiments, a database service (“Fonepage Database”) provides access to databases in a manner customized for mobile devices. In one example, databases can be configured for storing Fonepages and resources associated with Fonepages. Application databases (“Fonepage Application Database”) may also be implemented in embodiments of the invention wherein the application databases maintain one or more network-based applications that can interact with user devices. Application databases typically maintain persistent information needed by Fonepage Applications executed on servers or user devices. In one example, a Web Application Database may be implemented as a database containing various persistent information needed by web-based applications utilized by the Fonemine Platform and associated subscribers and devices.

In certain embodiments, network search capabilities are provided as a network service. Information access on mobile devices can be enhanced using search mechanisms optimized for mobile devices and supported by Fonemine-customized crawlers and databases. Supported search methods include searches based on keywords and person or entity (White Pages) and search category (Yellow Pages). Fonemine search mechanisms can include consideration of direction by user preference, user context awareness, geographical awareness, session focused, recent history awareness, and history sensitivity. Thus, it will be appreciated that Fonepage systems can execute search methodologies that incorporate device, user and system information to facilitate focused searches such as search by neighborhoods, resident recommendations, results incorporated with navigation information, relevance based on multiple level of history and popular searches organized by category, location and so on.

In certain embodiments, crawlers may be provided to search, index and document network information. Crawlers can be seeded by the Fonemine Platform in a variety of ways, including correlation based on a variety of metrics such as classification based, distance based, relevance based, real-time based, frequency of use based, and value-to-business based. Typically, information for seeding may include address of business facilities, hours of operation, services provided and contact information. Additionally, combinations of weighted information can be used to improve search speed and consistency. In many embodiments, crawlers can search using telephone-based navigation rather than conventional web-browser navigation methods. Customizable rules are typically maintained for mobile devices and users for directing the crawl behavior and crawl constraints may be provided. It will be appreciated that crawlers may update search results at frequency selected by some combination of user preferences and system configuration. Additionally, validity criteria may be provided to verify correctness of results. Such validity criteria may include independent verification of results by external organizations and external processes.

In certain embodiments security features such as maintenance of attribution information and privacy controls may be provided. Geographic crawling can be supported whereby cataloging and indexing based on specific countries can be provided. It will be appreciated that geographic crawling provides particular benefit where specific countries such as India, China, and Brazil are weakly indexed by the current world-wide-web.

Fonepage Structure

In certain embodiments, data of various types can be combined, cross-referenced or otherwise associated to generate a Fonepage. In certain embodiments, visible content is a predominant form of data, representing information to be displayed to a subscriber. Fonepages can support data representing hidden characteristics such as indirections, pointers, indexes and other data that may provide access to content, using, for example, search mechanisms, categorization and queries, etc. Hidden characteristics may also include keywords, site-unique name/number and other categorization hints. In certain embodiments, Fonepages can include meta-data adornments for enabling the formatting and presentation of content, scratchpad data organized as a whiteboard for viewing and modification by a plurality of connected consumers.

TABLE 1

| | Personal | Business-Public | Business-Private |
|---|---|---|---|
| Properties | Fonepages | Fonepages | Fonepages |
| Audience | Consumers | Customers (consumers) | Mobile workforce |
| Pricing Structure | FREE | Initial Free; | PAID |
| | | Subsequent PAID | |
| Default Access | Private t | Public | Private |
| Granularity | One per consumer | One per business | One per business-group |
| Fone-number anonymity | Yes | No | No |
| Forwarding | Yes | No | No |
| (shortcodes?) | | | |
| Update frequency | Medium-High | Low | High |
| Typical operations | Get/Post | Get/(sometimes post) | Post/Get |
| Content Owner | Consumer | Commercial business | Group administrator |
| Group relevance | Yes | No | Yes |
| Access scope | Variable | Local | Group-Local |
| Preference driven | Yes | No | Group-preference |
| m-commerce | No | Yes | No |
| Notifications | Yes | No (PAID) | Yes |
| Actionable Alerts | ? | No (PAID) | Yes |
| “whiteboard” | Yes | No | Yes |
| Location specificity | ? | Yes | Yes |
| Ability to modify | Free | PAID | PAID |
| Messaging | NO(PAID) | NO(PAID) | Yes |
| Polling/Aggregation | Free | PAID | Free |

In certain embodiments, Fonepage can provide views of information based on user identification such that consumers receive a customized view of the information created by publishers and developers of the information. In some embodiments user identification can categorize user accesses as personal, public and private and may further limit commercial access to public and private categories. Table 1 provides examples of classification of Fonepages in some embodiments.

In the example shown in Table 1 Personal Fonepages can be used by consumers to organize, personalize, present, publish, and share their personal information. Sharing may be enabled by configuring access rules to allow global access or access by specified third parties. An example of a personal Fonepage is provided in FIG. 6. Business Fonepages are typically used by businesses to publish and share business critical information with customers, potential customers such as consumers, and with employees. Employees may be located remotely, for example in branch offices, and may be mobile or field employees (including field service technicians, sales force, and support employees). Thus, public business Fonepages targeting customers and potential customers, and business-private Fonepages targeting employees can be implemented to service these and other categories of user.

Certain embodiments support automatic response systems that direct callers through a menu tree to desired information or contacts. Conventional systems are generally based on voice and tone dialing capabilities of a telephone and are necessarily linear in nature. In contrast, Fonemine-enabled systems can provide multimedia menus. Upon recognizing a Fonemine enabled user device, a response system may provide a complete menu structure in the form of a Fonepage. In some embodiments, a localized menu structure is provided based on location of the user device, home or business address information of the user where available to the response system or based on specific geographic information received from the user or system administrator. Additionally, in many embodiments, a user may receive a menu structure configured and transmitted by a third party, such as a customer support representative, a website or conventional voice response system.

In many embodiments, Fonemine enabled response systems operate using FONEWORD—a keyword/mnemonic based number entry subsystem—in which a caller can enter a FONEWORD to access a desired customer service number (e.g. 1-800 number) or to a predetermined direct dial number. By combining profile information associated with a user, geographic information associated with desired services, account information and positional information, rapid navigation of a menu tree can be achieved through the elimination of multiple steps in menu trees. Additionally, menus presented to a Fonemine user device can be in text or graphics form, allowing a user to make a desired selection quickly and accurately. Further, location-specific information permits rapid access to local services.

In certain embodiments, pre-defined forms can be created by users that can be provided to response systems for customizing menu structures and facilitating accurate responses. The pre-defined forms can include information that includes customer support, field access, pre-sales, financial service, information services, etc.

In certain embodiments, users may access Fonemine services by creating a user account. User accounts can include public access accounts, subscriber accounts, content provider accounts and other accounts. Accounts are typically associated with at least one primary fully qualified telephone number. A fully qualified number is as follows: <country dialing prefix><area code><telephone number>. Anonymous telephone numbers may be supported. For example, a number 1234567890, which is not technically a “valid” telephone number: but can translate to a valid fully qualified telephone number, e.g., 1800 Fonemine based on the region of the world (country) the target is in

In one example, a consumer account can be created from a desktop computer. Consumers may create an initial personal Fonepage or select a default Fonepage that may customizable at a later point in time. Account creation can be facilitated through a web site, by Email request and by telephone call to a service organization. A new account typically requires at least a mobile telephone number to be associated with the account, and an initial password. In many embodiments, an agent may be transmitted to the mobile device during or after account registration. In at least some embodiments, the agent may participate in account creation by providing information used to create the account or Fonepages associated with the account. It will be appreciated that similar processes can be implemented for creating accounts associated with land-line telephones and for desk top computer usage.

In certain embodiments, a business may create a business account for providing services and information to customers and potential customers. Business accounts can be created using a desktop computer and some mobile user devices. In many embodiments, account creation may also be created through written requests or by telephone call to a service center. Business account creation includes entry of demographic information, billing information and selection of Fonepage forms, content and capabilities. The new business may create its own Fonepages, request Fonepage creation based on business requirements or may begin operations with configurable template Fonepages.

In many embodiments, an editor (“Fonepage Edit”) is provided in client software. Typically, the editor supports editing of content of Fonepages at a desktop computer or directly on a mobile device. Mobile device editing can be implemented with entry assistance tools that facilitate data entry using restricted capability keypads. The editor can be initiated by command that specifies a locator, handle, filename or other identifying information associated with the desired Fonepage. The editor typically supports functions including entry of changes, preview of modified content, and change commitment. In many embodiments, modified Fonepages are received by a server and processed prior to entry in a database. Processing may include user authentication, validation and verification of linked material and propagation of authenticated pages. The editor may add new FonePages; it will be appreciated that new pages will typically be added using a desktop computer although a mobile user device can be used if the user device has sufficient display and data entry capabilities.

In certain embodiments, anonymous pages and vanity pages are provided that may be based on Foneword. For example, new Fonepages can be generated and linked to existing pages, or provided as top level, universally-addressable Fonepages.

In certain embodiments, users can create events and issue invitations by mobile or desktop device. Typically, a user creates a list of invited guests and specifies an event (such as a meeting or teleconference, etc.). The event can be created prior to creation of invitations and can also be created concurrently with the associated event. Typically, when a user designated as the event organizer, creates or modifies an event page, a notification of the new or altered event can be automatically sent to invitees. Invitees may view and respond to the invitations. Event pages created with the event are deleted when the event has terminated. Event pages can be used to manage and document events including, for example, tracking attendance, determining if quorum has been reached and so on.

In certain embodiments, Fonepages may be linked to other Fonepages. In some embodiments, a link can be created to another Fonepage even if the target page is not directly addressable or accessible. A link can be established from a parent Fonepage using a handle-on-target to identify the target page.

In some embodiments, Fonepages can be applied to support a variety of additional functions including, maintaining context, preferences and subjective other criteria and associating rankings with Fonepages based, for example, on viewer ratings. In some embodiments, links can be used for grouping pages to describe user-controlled or Fonemine-controlled relationships. In certain embodiments context information may be associated with a user account.

Context information typically includes information and links that identify targets of previous searches and destinations reached following previous navigations. For example, a user may enter a telephone number as a starting point to a search or to establish contact with another Fonemine user. Upon first entry of a telephone number, the user may be presented with one or more Fonepages that assist in navigation to desired information, a web page or a multimedia connection. Subsequent searches associated with the telephone number can be accelerated based on prior results. Further, context information can be associated with a telephone number such that the number can be indicated by a text or graphics identifier for future use. Context is typically recorded by user command. Context information can be stored to enable “virtual” evaluation of fonepage navigation, thus ensuring that the user gets to a dynamic” target page, without the need to create or remember complex URLs as “bookmarks.”

Business Methods

Various business methods can be implemented to support operation of Fonemine services including subscription based service having multiple levels of service over predetermined periods of time. Transaction based (per call) service can also be provided in which billing processes are associated with quantity of Fonepage accesses, alerts and Fonepage sends (for forms based and other Fonepages). Further Event based billing may be applied for individual or one-time events based on duration of the event. In addition, Fonemine can also provide value-added up sell services to consumers where basic Fonepage accesses and updates are provided to consumers.

It is apparent that the above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

1. A method comprising:
receiving from a caller, a call directed to a device on a telephone network;
optionally returning to the caller displayable information, the displayable information including one or more selectable options;
responsive to a first option selected by the caller, providing additional displayable information to the caller; and
responsive to a second option selected by the caller, establishing a telephonic connection between the caller and the device.

2. The method of claim 1, and further comprising the step of authenticating access rights of the caller.

3. The method of claim 1, wherein the displayable information is configured according to preferences of a subscriber associated with the device.

4. The method of claim 1, wherein the displayable information is configured according to capabilities of a telephone associated with the caller.

5. The method of claim 1, and further comprising the step of determining location of the caller.

6. The method of claim 5, wherein the step of determining location includes obtaining from the telephone network, locating information associated with the device.

7. The method of claim 5, wherein the step of determining location includes obtaining from a GPS system, locating information associated with the device.

8. The method of claim 5, wherein the displayable information is configured according to the location of the caller.

9. The method of claim 1, and further comprising the step of establishing a telephonic connection between the caller and another device on the telephone network in response to a third option selected by the user.

10. The method of claim 9, wherein the third option is included in the additional displayable information.

11. The method of claim 1 and further comprising the step of optionally returning to the caller an audio presentation comprising translated portions of the displayable information.

12. A system, comprising
one or more servers for delivering displayable information, the information including at least one option to establish a voice connection with a receiving telephone, and
a calling telephone adapted to receive and display the displayable information, wherein
the displayable information is delivered in response to a call received from the calling telephone, and
the one or more servers maintain multimedia content associated with a subscriber and the displayable information includes a link to the multimedia content.

13. The system of claim 12, wherein the displayable information includes a portion of the multimedia content.

14. The system of claim 13, wherein the displayable information includes additional content generated upon receipt of the call.

15. The system of claim 12, wherein the displayable information includes a portion of the multimedia content related to location of the calling telephone.

16. The system of claim 13, wherein the subscriber is associated with the receiving telephone.

17. The system of claim 12, and further comprising a translator, wherein the translator translates the displayable information to audio content and the one or more servers delivers the audio content to the calling telephone.

18. The system of claim 12, and further comprising an agent for initiating the call and receiving the displayable information responsive to the call.

19. The system of claim 12, wherein the displayable information includes an option for automatically establishing a voice connection between the calling telephone and a target telephone.

20. The system of claim 19, wherein the target telephone is the receiving telephone.

21. The system of claim 19 wherein the target telephone is identified in the displayable information.

22. The system of claim 14 wherein the additional content is generated according to time of day of receipt of the call.

23. The system of claim 16 wherein the portion of the multimedia content is selected based on a calendar associated with the subscriber.

24. The system of claim 14 wherein the additional content is generated based on identifying information associated with the calling telephone.

25. The system of claim 24, wherein the identifying information includes a telephone number.

26. The system of claim 16 wherein the portion of the multimedia content is selected based on the telephone number of the calling telephone.

27. A multimedia content generator for mobile devices, comprising:
multimedia content associated with a subscriber, wherein the multimedia content is maintained on one or more servers;
a page creation tool configured to generate from the multimedia content information presentable on a telephone; and
a connection-based protocol that interacts with SMPP for exchanging data and instructions between the one or more servers and at least one telephone,
wherein the page creation tool comprises systems and software to generate source information describing the multimedia content, the source information including directives consistent with a rendering adornment language.

28. The content generator of claim 27, wherein the presentable information includes text and graphics information.

29. The content generator of claim 27, wherein the presentable information includes audio information.

30. The content generator of claim 29, wherein the audio information includes an audio translation of a portion of the multimedia content.

31. The content generator of claim 27, wherein the presentable information includes audio-visual information.
